(19) United States
(12) Patent Application Publication
(10) Pub. No.: US 2006/0276083 A1
(43) Pub. Date: Dec. 7, 2006

(54) Serial advanced technology attachment connector

(75) Inventor: Zheng-Heng Sun, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/389,951

(22) Filed: Mar. 27, 2006

(30) Foreign Application Priority Data
Jun. 4, 2005 (CN) 200510035153.0

(51) Int. Cl. H01R 33/00

(52) U.S. Cl. 439/638

(57) ABSTRACT

A Serial Advanced Technology Attachment (SATA) connector comprising a SATA plug, a power connector and a main body which has a slot defined in a front surface thereof, the slot having another SATA plug and a power plug therein, the SATA plugs are connected with a signal wire, and the power plug of the slot and the power connector are connected with a power wire. It is simple and economical to use the SATA connector for connecting a computer with a SATA data storage device.

### CROSS-REFERENCE TO RELATED APPLICATION

Relevant subject matter is disclosed in co-pending U.S. patent application entitled “SERIAL ADVANCED TECHNOLOGY ATTACHMENT CABLE” filed on Jan. 30, 2006 with attorney docket No. 14963-53806, assigned to the same assignee with this application.

### BACKGROUND OF THE INVENTION

1. Field of the Invention

The present invention relates to an electric connector, and particularly to a Serial Advanced Technology Attachment (SATA) connector between a computer and a SATA data storage device.

2. General Background

Computers are widely used in the fields of E-commerce, E-business, Home network, Internet work station and so on. Each computer has a data storage center, e.g. hard disk, where computer software and business data information are saved. When the computer runs, the computer Central Processing Unit (CPU) continuously accesses the hard disk and retrieves data from the hard disk or stores data to the hard disk. For compatibility, the hard disk drive interfaces are standardized. There are many hard disk drive interface standards and the Small Computer System Interface (SCSI) families and Advanced Technology Attachment (ATA) families are the most famous in the last decade.

The parallel ATA specification has defined the standard storage interface for PCs since the early 1980s. Parallel ATA provides low cost, broad operating system support, and steady evolution. Over time, parallel ATA has continuously evolved to support higher speed and performance. However, due to several reasons, including performance headroom, cabling issues, and voltage tolerance requirements, a new storage interface known as Serial ATA (SATA) has recently been created.

SATA may combine software transparency, low cost, scalability, and design flexibility to overcome the limitations of parallel ATA. Point-to-point data rates of 1.5 Gbps may be attainable with SATA. Therefore, SATA connectors are usual components on the mother board of a computer.

What is needed is a SATA connector for connecting the computer with a SATA data storage device.

### SUMMARY

A SATA connector of a preferred embodiment includes a SATA plug and a main body. The main body has a slot at the front surface thereof, and there are a SATA plug and a power plug mounted in the slot. The SATA plugs are coupled with a signal wire, the power plug of the slot and a power connector are coupled with a power wire.

It is simple and economical to use the SATA connector for connecting a computer with a SATA data storage device.

Other advantages and novel features will become more apparent from the following detailed description when taken in conjunction with the accompanying drawings, in which:

### BRIEF DESCRIPTION OF THE DRAWINGS

FIG. 1 is an isometric view of a SATA connector in accordance with a preferred embodiment of the present invention;

FIG. 2 is similar to FIG. 1, but viewed from another aspect; and

FIG. 3 is an isometric view of the SATA connector of FIG. 1 connecting to a SATA hard disk.

### DETAILED DESCRIPTION OF THE EMBODIMENT

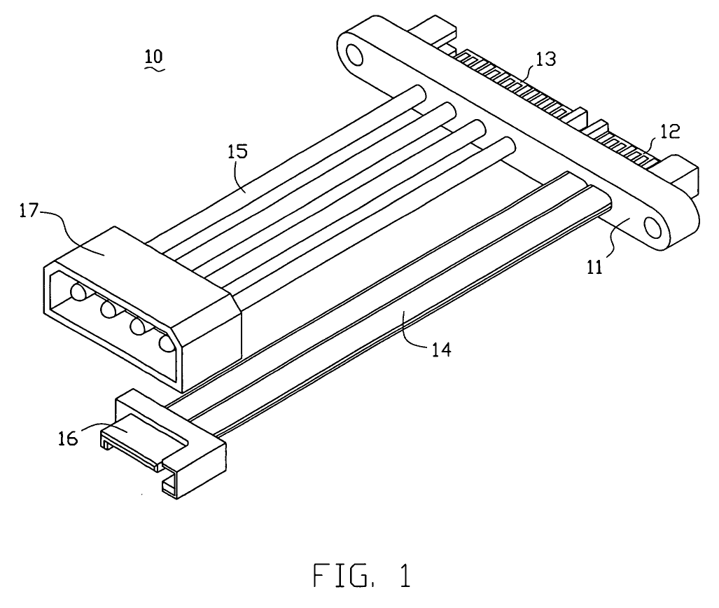

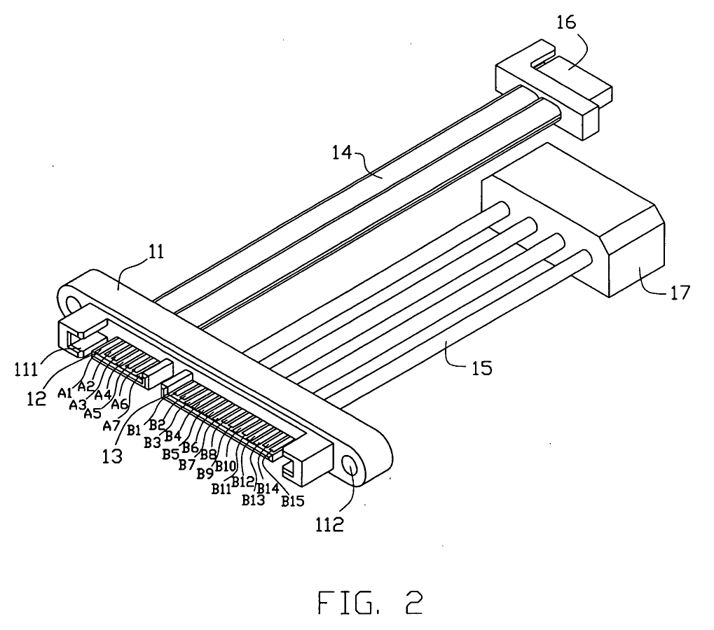

Referring to FIG. 1 and FIG. 2, an interface for electrical connection like a SATA connector 10 of an electronic device like a computer in accordance with a preferred embodiment of the present invention includes a SATA plug 16 and a main body 11. The main body 11 is fixedly installable to a window of the computer, and has a slot 111 at the front surface thereof. There are a SATA plug 12 and a power plug 13 mounted in the slot 111. The SATA plugs 12 and 16 are coupled with a signal wire 14, the power plug 13 of the slot 111 and a power connector 17 are coupled with a power wire 15. The main body 11 of the SATA connector 10 further includes a pair of fixing holes 112 at two opposite sides thereof.

The SATA plugs 12 and 16 include a plurality of signal pins, the signals that the pins transmit are shown in the following table:

| | PINS | DESCRIPTION |
|---|---|---|
| SATA | A1 | GND |
| PLUG | A2 | A+ |
| | A3 | A− |
| | A4 | GND |
| | A5 | B+ |
| | A6 | B− |
| | A7 | GND |

The power plug 13 and the power connector 17 include a plurality of signal pins, the signals that the pins transmit are shown in the following table:

| | PINS | DESCRIPTION |
|---|---|---|
| POWER | B1 | — |
| PLUG | B2 | |
| | B3 | |
| | B4 | GND |
| | B5 | |
| | B6 | |
| | B7 | +5 V DC |
| | B8 | |
| | B9 | |
| | B10 | GND |
| | B11 | |
| | B12 | |
| | B13 | +12 V DC |
| | B14 | |
| | B15 | |

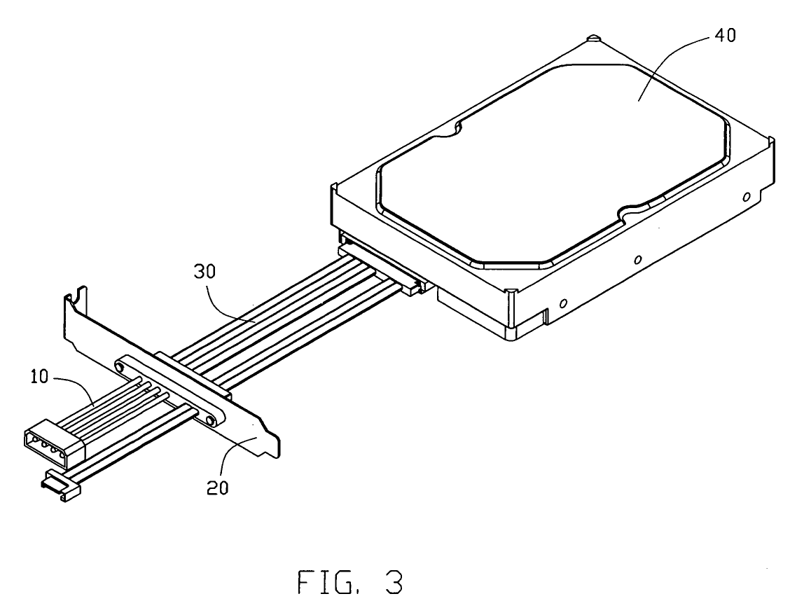

Referring to FIG. 3, the main body 11 of the SATA connector 10 is mounted to a cover plate 20 of a computer via two screws inserted into the fixing holes 112 and mating the corresponding holes on the cover plate 20. The SATA plug 12 and the power plug 13 of the SATA connector 10 are mounted to a SATA cable 30 via the slot 111 mating with corresponding pegs of the SATA cable 30. The SATA cable 30 bridge connects the SATA connector 10 with a part device like a SATA hard disk 40. The SATA plug 16 can connect to a SATA socket of the computer, and the power connector 17 can connect to a power supply of the computer.

The SATA connector 10 can connect the computer with the SATA hard disk 40, and makes the signal transmission between a computer and a SATA storage simple.

It is to be understood, however, that even though numerous characteristics and advantages of the present embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Serial Advanced Technology Attachment (SATA) connector comprising a SATA plug, a power connector and a main body which has a slot defined in a front surface thereof, the slot having another SATA plug and a power plug therein, wherein the SATA plugs are connected with a signal wire, and the power plug of the slot and the power connector are connected with a power wire.

2. The SATA connector as claimed in claim 1, wherein the main body further includes a pair of fixing holes at two opposite sides thereof.

3. A Serial Advanced Technology Attachment (SATA) device comprising:
a storage device;
a SATA cable; and
a SATA connector connecting the storage device via the SATA cable, the SATA connector comprising an inside module and an outside module; wherein the inside module is connected to a computer and the outside module is connected to the SATA cable.

4. The SATA device as claimed in claim 3, wherein the inside module comprises a SATA plug and a power connector.

5. The SATA device as claimed in claim 3, wherein the outside module comprises a SATA plug and a power plug.

6. The SATA device as claimed in claim 3, wherein the SATA connecter includes a pair of fixing holes at two opposite sides thereof for mounting with a cover plate of the computer.

7. A system for connection comprising:
an electronic device;
a part device for functional extension of said electronic device installable outside said electronic device;
an interface defined along a side of said electronic device comprising an electrical connector facing inside said electronic device from said side thereof for electrical connection with said electronic device, and a cable, signally connectable with said electrical connector, extending out of and away from said electronic device so as to be electrically connectable with said part device and further to establish electrical connection between said part device and said electronic device.

8. The system as claimed in claim 7, wherein said electrical connector of said interface comprises a main body fixably located at said side of said electronic device.

9. The system as claimed in claim 7, wherein at least one part of said electrical connector and said cable of said interface is compatible with the Serial Advanced Technology Attachment (SATA) standard.
